(19) United States
(12) Patent Application Publication
(10) Pub. No.: US 2011/0229329 A1
(43) Pub. Date: Sep. 22, 2011

(54) Propeller augmentation

(76) Inventor: Anthony C. Occhipinti, Kenner, LA (US)

(21) Appl. No.: 12/661,648

(22) Filed: Mar. 22, 2010

(51) Int. Cl. B64C 27/46

(52) U.S. Cl. 416/223 R

(57) ABSTRACT

The invention relates a fluid or air propeller propulsion apparatus using the state of the art propeller that reduces the typical propeller slipstream disc contraction taking place very close to the propeller tips, containing an inlet slot on the leading edge of the propeller some distance measured from the propeller tips and connected internally to an exit tip slot at the propeller trailing edge. Fluid or air enters the leading edge slot during rotation of the propeller and is acted upon by centrifugal force varying directly with the propeller speed causing the fluid or air to be accelerated thru the internal passage and out the trailing edge exit slot parallel to the cambered face of the propeller at less than a right angle to the trailing edge, inducing flow at zero or low forward speed previously with little or no flow at the propeller tips and at greater speeds, increasing the propeller capacity, and adding an additional jetting action or bootstrapping which causes the propeller to turn more easily, all of which increases the propeller thrust and efficiency.

### BACKGROUND OF THE INVENTION

Propulsion systems have been improved by scientists, researchers, engineers as well as manufacturers to the present state of the art of fluid or air propellers, It is well known the propeller slipstream disc contracts between 0.816 to 0.92 depending on the propeller forward velocity from zero and low forward speed, and the contraction occurs near the outer edge of the propeller disc, Static Propellers & Helicopter Rotors, AHS 25^{th} Forum 1969, and Fluid-Dynamic Lift, Chapter XII, S. F. Hoerner, and H. V. Borst, Second Edition, published by Liselotte A. Hoerner, 1985, 7628 Staunton Place, N. Mex. 87120. It has been suggested propeller disc contraction has not been completely addressed. Airfoils have been designed to reduce trailing vortices, Chapter III, and Chapter XII FIG. 13. The present invention adds the reduction of disc contraction by inducing fluid or air flow at little or no forward speed, and at greater speeds, increasing the loading of the propeller disc per unit area, thus increasing the propeller capacity. Countless stationary air handling units and mobile units using air cooling will benefit from this augmented propeller apparatus.

### SUMMARY OF THE INVENTION

The present invention relates to using the state of the art propeller containing an internal passage that connects a leading edge inlet slot and a trailing edge exit slot, allowing the fluid or air entering the propeller at approximately ninety degrees by way of the leading edge slot to be acted upon and forced out of the trailing edge propeller tip by centrifugal force varying directly as the speed of the propeller rotation. The exit trajectory of the fluid or air is parallel to the cambered face of the propeller and at approximately forty-five degrees to the longitudinal axis of the propeller. The velocity and capacity of the fluid or air varies directly as the speed of rotation.

It is an object of the invention to provide a method of propeller propulsion with less propeller slipstream disc contraction, thus producing more thrust and efficiency.

It is an object of the invention that the exiting fluid or air from the trailing edge exit induces flow over the cambered face of the propeller apparatus, adds an amount of bootstrapping to the capacity if the propeller, and by the jetting of the exiting fluid or air causes the propeller to turn more easily.

It is also another object of the invention to provide a method of propeller propulsion to improve the propeller propulsion efficiency.

These objects and others are achieved in accordance with this invention which embodies, a propeller either solid with a passage connecting or hollow core, with an inlet on the leading edge some distance or approximately twenty percent of the propeller diameter measured from the propeller tip to an exit slot on the trailing edge of the propeller tip having the fluid or air exiting parallel to the cambered face of the propeller and at approximately forty-five degrees to the longitudinal axis of the propeller.

The characteristics of the preferred device and its principle of operation, will be more fully understood by reference to the following more detailed description, and the attached drawings to which reference is made. The various components of the device, a propeller, are referred to in terms of reference numerals and letters, similar numbers being used in the different figures to designate components. In describing certain components, and features thereof, subscripts have been used with whole numbers for convenience to describe subcomponents of a different part.

The invention will now be described in connection with the accompanying drawings:

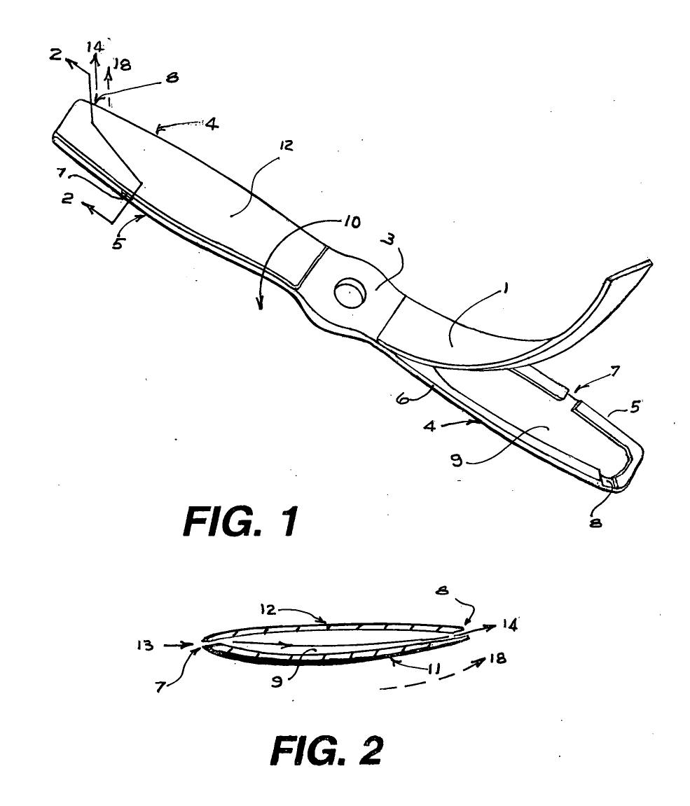

FIG. 1 is a perspective view of a standard JZ Zinger 10/6 10 inch conventional test propeller with an airfoil of the prior art modified by showing the addition of a thin veneer applied to the side opposite to its camber face 11, showing side opposite the cambered face 11 that has been relieved 9 between a slotted inlet 7 on the leading edge 5 connecting a trailing edge 4 exit slot 8 near its tip. The figure is drawn for convenience of the viewer showing partially peeled back surface 1 of the internal passage connecting the inlet and outlet slots;

FIG. 2 is a cross section view of the test propeller along lines 2-2 showing the connection 9 between the inlet 7 located on the leading 5, and the outlet 8 located on the trailing edges 4, and the direction of flow thru the internal passage 9 connecting the inlet at 13 to the outlet at 14 respectfully;

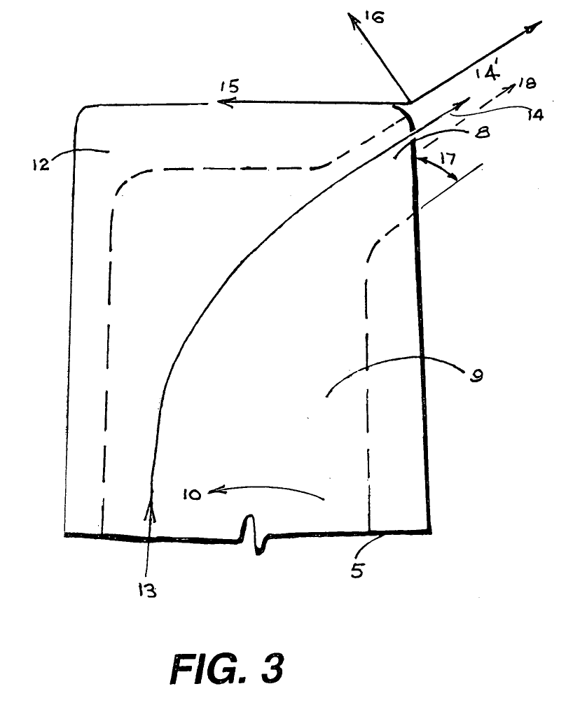

FIG. 3 is a perspective end view of a test propeller showing fluid or air flow exiting 14 at less than a right angle to the trailing edge from the tip of the propeller and parallel to the cambered face of the propeller 11, the flow vectors of the exiting fluid or air—velocity of air flow along the blade face 14′, blade tip velocity 15, and resultant air velocity 16. Refer, e.g. to Steam, Air and Gas Power, Wm. Severns, and Howard E. Degler, John Wiley & Sons, 4^{th} Edition 1948, p. 218, NY and London; and

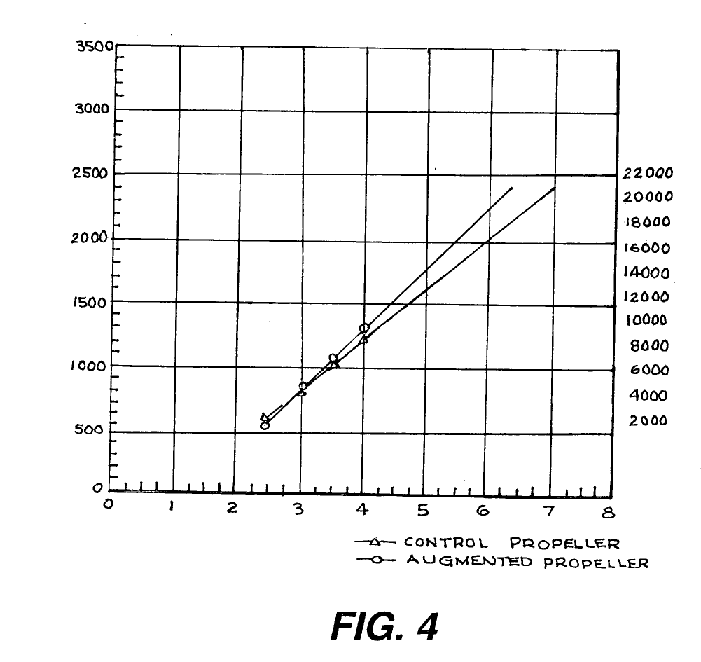

FIG. 4 showing performance curves of the control propeller and the third augmented propeller.

### EXAMPLES AND DEMONSTRATIONS

The following examples and demonstrations exemplify the augmented propeller of this invention; comparative data being presented to demonstrate the advantage in improved thrust and efficiency achieved pursuant to the practice of this invention.

Prior flight tests were made in a Wittman 125 horsepower retractable gear monoplane to obtain data of the magnitude of the slipstream disc contraction of a propeller driven airplane at airspeeds of a 160 miles per hour. The airplane was equipped with a fixed pitch 68/75 propeller and further equipped with a an airspeed indicator and pitot system mounted in the propeller slipstream taking airspeed readings approximately 6 inches to the rear of the propeller. The pitot tube was moved in increments of one inch starting at the tip of the propeller after each test flight flown at 160 miles per hour. The slipstream contraction was measured to be approximately 6 inches for 68 inch diameter propeller or approximately 0.911, which is reasonable compared to the studies by S. F. Horner and H. N. Borst reference above. These results demonstrated a reduction of the slipstream disc contraction of the test aircraft would increases the flow of air at the propeller tips, and is a viable subject for improvement in performance and efficiency as the following tests below demonstrate.

Tests of 10 inch diameter two bladed 10/6 propellers manufactured by JZ Zinger Company were performed on a dynamometer. The first propeller tested, marked as the control propeller, was covered with a thin veneer 1 on the back side 12 opposite the propeller cambered face 11. The second test propeller back 12 was modified by carving a channel 9 between the inlet 7 at the leading edge 5 and the tip outlet 8 at the trailing edge 4, the inlet 7 on the leading edge 5 measures approximately twenty percent of the diameter from the tip. Flow from the inlet slot 7 located of the leading edge 5 allows flow to the outlet at the trailing edge 8 tip wherein flow is directed 14 parallel to the camber propeller face 11 and at an angle of approximately forty-five degrees 17 to the longitudinal axis of the propeller. The back 12 of the second test propeller was carved out and covered with a thin veneer 1, creating a direct passage 9 between the inlet slot 7 and outlet slot 8 of minimum size. The third test propeller was also modified by carving an internal passage creating a larger hollow core 9 after also being covered with a thin veneer 1. Except for the size of the internal passage 9 between the inlet 13 to the outlet 14, FIG. 2, in all other respects the third test propeller was identical to the second test propeller. Both the second and third propeller inlets 7 and outlets 8 were of the same size and located similarly as the leading edge 5 and trailing edge 4. The inlets measured 0.026 inches×0.25 inches and the outlet measured 0.026 inches×0.1563 inches. The direction of rotation 10 were the same:

Demonstration One: The control propeller provided an average 1175 grams thrust reading for an input of 4 amps at 8265 rpm.

Demonstration Two: The second propeller provided an average 1205 grams thrust reading for an input of 4 amps at 8230 rpm.

Demonstration Three: The third propeller provided an average of 1226 grams thrust reading for an input of 4 amps at 8270 rpm.

There is a 4.3 percent improvement of thrust of the control propeller by the third propeller.

Subsequent tests were made with the control propeller and third propeller since the third propeller internal passage was of sufficient capacity, hollow core, as demonstrated to have an increase in thrust readings, induced flow over the propeller apparatus camber 18, as well as having an average increase in rpm. The subsequent tests as recorded in FIG. 4 of both control propeller and the modified augmented third test propeller were made at inputs of 2.5 amps, 3.0 amps, 3.5 amps, and 4.0 amps and the results were plotted as shown. At 2.5 amps the control propeller has more thrust. The left y-axis of FIG. 4 is a graph of Thrust in increments of 100 grams, the right y-axis is the propeller Speed in increments of 2000 revolutions per minute, and the third x-axis is the Input to the propeller in increments of 0.25 amps. At 3.0 amps the modified augmented third propeller showed an increase which continued throughout the rest of the plots. At 4.0 amps the augmented propeller showed a 4.3 percent increase in thrust, and when projected to a tip speed of approximately 900 feet per second is an approximately 11.6 percent thrust improvement.

It is apparent that various modifications and changes can be made without departing from the spirit and scope of the present invention. Changes in absolute dimensions of the parts, materials of construction used, and the like will be apparent to those skilled in the art.

1. An apparatus characterized as a foil having a cambered surface extending from the leading edge to the trailing edge of said foil as a state of the art propeller which leading edge of said propeller has an inlet located some distance from the propeller tip which connects internally to an outlet on the trailing edge at the propeller tip allowing internal flow from the leading edge inlet to the trailing edge outlet;

2. The apparatus of claim 1 wherein the propeller operates in a fluid or air;

3. The apparatus of claim 1 wherein the foil is a state of the art propeller which is provided with a leading edge inlet or slot parallel to the leading edge and also having a trailing edge exit slot of approximately the same width, and a length sufficient for propellers of varying diameters;

4. The apparatus of claim 1 wherein the fluid or air entering the leading edge inlet slot at approximately a right angle to the leading edge and the air exiting the trailing edge, slot parallel to the cambered face of the propeller and at an angle measured from the tip of approximately forty-five degrees to the longitudinal axis of the propeller; and

5. The apparatus in claim 4, wherein the flow fluid or of air entering the leading edge inlet or slot during the rotation of the propeller apparatus by centrifugal force thru the internal connection from the leading edge inlet or slot to the trailing edge exit or slot reducing the slipstream disc contraction at the propeller tips at zero or low forward speed and at greater speeds, and inducing flow over the cambered face of the propeller apparatus increasing propulsion, plus bootstrapping by the jetting effect of the fluid or air exiting the trailing edge at the tip of the propeller apparatus.
